(19) United States
(12) Patent Application Publication
(10) Pub. No.: US 2015/0179071 A1
(43) Pub. Date: Jun. 25, 2015

(54) METHOD FOR OVERTAKING ASSISTANCE USING A DEVICE INTEGRATING A GPS MODULE COUPLED TO A RADIOFREQUENCY MODULE

(71) Applicant: ETUDES ET REALISATIONS TECHNIQUES FRANCAISES EN COMMUNICATION ET POSITIONNEMENT DE MOBILES, Ploemeur (FR)

(72) Inventors: Jean-Francois Canac, Larmor Plage (FR); Marc Lajara, La Villedieu (FR)

(21) Appl. No.: 14/415,730

(22) PCT Filed: Jul. 15, 2013
(86) PCT No.: PCT/FR2013/051692

§ 371 Date: Jan. 19, 2015

(30) Foreign Application Priority Data
Jul. 20, 2012 (FR) 12 02069

(51) Int. Cl. G08G 1/16

(52) U.S. Cl. CPC G08G 1/161; G08G 1/166

(57) ABSTRACT

A method for assistance in overtaking a vehicle in the framework of an automobile race. The global positioning data acquired by a satellite global positioning module coupled to a radiofrequency module is transmitted by radio frequency from a requestor automobile vehicle to a receiver automobile vehicle. The global positioning data is analyzed by the receiver vehicle and depending on the relevance of the analyzed data, the receiver vehicle warning its driver of the imminence of an overtaking maneuver. A radiofrequency signal is manually or automatically transmitted from the receiver vehicle to the requestor vehicle to inform the requestor vehicle that the receiver vehicle has been made aware of an imminent overtaking maneuver.

The present invention relates to the use of devices designed for selectively transmitting and receiving by radiofrequency data generated by a module for global positioning by satellite, or satellite guidance system (or GPS for Global Positioning System), and designed to equip automobile vehicles in order to warn them of the imminent occurrence of an overtaking maneuver by means of an audio and/or visual alarm, the objective being to render dangerous overtaking maneuvers safer.

This use, particularly useful in the framework of automobile races, allows the indication of the presence of at least one vehicle in proximity to another, with an assistance implementing the analysis of GPS data. The exchange of GPS data allows the passengers of the automobile receiving the signal transmitted by radiofrequency to be made aware of the imminence of an overtaking maneuver based on reliable information.

A system for radiofrequency communications between various vehicles, for exchanging data relating to their positioning, is known from the patent application US20040061600. This type of system is provided for automatically activating alarms or automatically triggering actions, which have to take effect in the receiver vehicle. However, such a system does not allow the competitors to partly manage the data transmitted by the system, and, to be able to get round the automated actions triggered following the reception of these data.

The aim of the present invention is to allow the automobile receiving the overtaking request to improve the quality of the decision taking so as to take the appropriate measures in order to ensure an overtaking maneuver under the optimum conditions of safety, such as alerting one another between vehicles that all the passengers involved are well aware of the imminence of an overtaking maneuver.

The terms “vehicle” or “automobile” are to be interpreted in the wider sense in the framework of the present invention and they notably include cars, trucks, motorbikes, quad bikes, etc.

The present application relates, according to a first aspect, to a method for assistance in overtaking a vehicle in the framework of an automobile race, comprising the steps consisting in:
transmitting by radiofrequency global positioning data acquired by a satellite global positioning module coupled to a radiofrequency module, from a requestor automobile vehicle to a receiver automobile vehicle;
analyzing the global positioning data transmitted by the requestor vehicle, from the receiver vehicle; and
depending on the relevance of the analyzed data, from the receiver vehicle, warning its driver of the imminence of an overtaking maneuver and manually or automatically sending a radiofrequency signal to the requestor vehicle, in order to inform said requestor vehicle that the receiver vehicle has indeed been made aware of the imminent overtaking maneuver.

Such a method, implementing the analysis of GPS data for the study of the relevance of a request for overtaking, facilitates the decision-taking of the competitors in an automobile race thanks to the filtering of the radiofrequency messages received. The triggering of non-relevant warnings which distract the competitors, as is the case when the radiofrequency module is not coupled to a GPS, is also avoided, the objective being the reinforcement of the safety of dangerous overtaking maneuvers. More particularly, such a method provides an intelligence solution which allows an overtaking request or an alarm to be taken into account, or not to be taken into account, depending on the respective positions of the vehicles, on their separation distances, on their headings and their speeds, and also situations where there are more than two vehicles. This method is adapted to both a rally and racetrack scenario, in order to send a warning according to the level of danger presented by the area where the overtaking maneuver is about to take place. Such a method may be used for generating alarms used to warn of situations of danger other than overtaking maneuvers.

Preferably, for use in a rally situation, the time delay between two radiofrequency transmissions for the same overtaking request (or an alarm) by the requestor vehicle is random and less than 250 ms (milliseconds), advantageously this time delay is in the range between 0 and 60 ms, and preferably this time delay is in the range between 20 and 40 ms. Radiofrequency collisions are thus avoided when several competitors request overtaking permission from the same competitor. In a rally situation, when an overtaking request or an alarm is activated, the requestor vehicle sends a message comprising its position (latitude and longitude), its speed, its heading, its reference number, its race number, its category (truck, car, etc.) and the overtaking request indicator. An event is recorded in its log. The very short message is transmitted in several bursts of several messages separated by random intervals of time in order to avoid collisions.

Preferably, for use on a racetrack, the transmissions are continuous every second, synchronized over time using the very precise time reference supplied by the GPS module. In the variant of operation on an automobile racetrack, the transmissions are continuous every second and are synchronized over time using the very precise time reference supplied by the GPS module, the purpose being to avoid the driver having to manually signal an overtaking request. The synchronized automatic transmission on a racetrack allows each vehicle to have a layout of the nearby vehicles. This method is adapted to the operation on a racetrack, because the number of vehicles involved is limited and an automatic alert is desired. It is not appropriate for the rally situation where the number of competitors can be several hundred; in this scenario, manual overtaking requests are then preferred. On a racetrack, the position will advantageously be characterized by the abscissa on the circuit calculated based on the longitude and latitude data supplied by the GPS (la transmission of the message is automatic once per second).

Preferably, in a rally situation, in the case of the manual overtaking request, a time delay of at least 6 seconds must be observed in order to renew an overtaking request to the same receiver vehicle. The transmission of the same overtaking request message is inhibited for at least 6 seconds, which is automatically managed by a timer system in an interface with the motherboard serving as a bus between, notably, the GPS and radiofrequency modules. This timer allows a situation to be avoided where competitors warn of an overtaking maneuver all at the same time. Thus, when a competitor sends an overtaking request, another request can only be sent by the same competitor at least 6 seconds after the preceding one.

Advantageously, when an overtaking request has not been acknowledged by a receiving automobile, it may be provided that no overtaking request can be sent by this same automobile, except by an action which forces the request (such as pressing an overtaking request button for more than 2 seconds). Such an action can be logged, in other words saved in memory in order to allow the history of an event to be reconstructed.

According to another aspect, the invention relates to a device for managing the overtaking between various vehicles in an automobile race incorporating:
a satellite global positioning module;
a module for transmission and for reception of radiofrequencies coupled to the global positioning module by means of a data processing mother board;
at least one signaling means;
at least one manual actuator (for use in a rally);
at least one automatic actuator;
a screen and a keyboard;
a power supply; and
a processor equipped with a storage system for the acquired data connected to the motherboard.

Such a device is well adapted to a use during automobile races in order to warn of overtaking maneuvers or of situations of danger. The device according to the invention is more particularly provided for equipping vehicles during rallies, and it then operates in manual overtaking request mode. This device is also well adapted for equipping the cars in races on automobile circuits, where it then operates in automatic overtaking request mode by continual transmission of the position message.

In a rally, the competitors can, by virtue of the manual actuator, make an overtaking request, and, when after a certain period the competitors do not acknowledge the overtaking request, an automatic signal is sent by means of an automatic actuator for signaling that the competitor has indeed received the request but has not validated it.

Preferably, the signaling means is an audible indicator in a rally situation. This can advantageously be a ‘buzzer’ or ‘beeper’ of higher than 110 decibels, potentially complemented with an LED lamp. On a racetrack, where the signaling means is preferably visual, an LED lamp or a small HD (high definition) screen of 3 to 3.5 inches and a quarter VGA (Video Graphics Array) is advantageously employed.

Preferably, the device according to the invention comprises two manual actuators which consist of a main remote button, for the overtaking requests, and a secondary remote button for the alarm activations. The alarm activation relates to the situations of danger, other than overtaking, such as accidents, competitors down out of view, or else stoppages at the exit from dunes. The LED lamp, previously seen in the framework of the invention, is able to be used to make the distinction between an overtaking request and an alarm. The buttons are remote, in other words they are placed so as to be accessible both by the driver and by his co-driver, in all circumstances (these buttons are not used on a racetrack where the radiofrequency transmission is continuous).

The power supply is advantageously a power supply with three-way input (internal battery, external main power supply, external back-up power supply).

It may be provided for the processor to analyze the data received in several steps essentially consisting in analyses of the relevance of the global positioning data in terms of position and relative speed of the requestor vehicles. On a racetrack, higher precision is necessary and the processor also carries out a comparison of the automobile profiles. These profiles are recorded during the qualification phases. The analysis of these profiles and the comparison with the actual behavior of the automobiles allows the calculation of the time delay before overtaking to be refined and hence allows the driver to be warned preferably 2 seconds prior to the overtaking maneuver.

Preferably, the screen is a transflective color screen (of 3 to 5 inches transflective) driven by the motherboard, of very high quality (of the HD quarter VGA type) and comprising a display mode for safety indications so as to serve as signaling media. Such a configuration is particularly well suited for warning the competitors of the overtaking situations in risk zones.

The present invention will be better understood upon reading the detailed description that follows, whose embodiments and their appended figures are presented solely by way of illustration and should not be considered as limiting in any way:

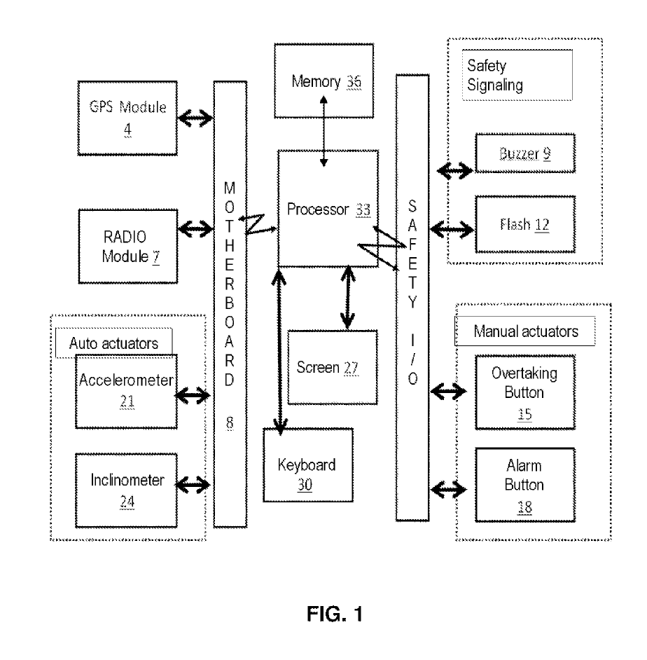

FIG. 1 shows the architecture of a device according to the invention.

### CONFIGURATION OF ONE EMBODIMENT OF THE DEVICE ACCORDING TO THE INVENTION

The device 1, whose architecture can be seen in FIG. 1, comprises a housing enclosing various elements, which mainly include:
a GPS module 4 which supplies the information on global positioning at a programmable frequency from 2 to 10 Hz;
a radiofrequency module 7 which allows the signaling between an overtaking requestor and the other competitors; it also allows the management of other tasks such as parameterization, unloading, etc.;
a motherboard 8;
safety signaling means: a high-power buzzer 9 (110 dB) and a flash 12;
manual actuators: button for overtaking request and acknowledgement 15, alarm trigger button 18; these are remote, in other words placed in the vehicle substantially between the driver and his co-driver (they are not necessary in racetrack mode);
automatic actuators: an accelerometer 21 and an inclinometer 24, which are used to trigger an automatic alarm;
a screen 27 and a keyboard 30 for inputting the parameters of the system: the adjustment of the sound level, the programming of the speed alarms, the display of certain messages such as “Sentinel Alarm”;
a processor 33 configured on the basis of a set of rules which analyze all messages received and study: the validity of the message, the relevance; and which triggers (or not) the signaling (audio or visual) of an overtaking maneuver or of an alarm depending on the respective positions, heading and speeds and on the performance profiles for the racetrack mode;
a memory 36 for recording the trace supplied by the GPS module and events such as: the sending or the reception of the messages, the acknowledgements; which can be used in the case of an accident or of litigation for analyzing the situation.

Since the device 1 is a safety system, it is designed to operate autonomously and hence includes dual sets of equipment, which are: an external GPS antenna for precision and an internal one for safety, an external power supply and a back-up power supply on internal batteries. In the case of an accident, if at all possible, it can continue to operate.

In FIG. 1, the term safety I/O signifies Input/Outputs to the safety media:

namely, media that absolutely must function: buzzer, flash for signaling and overtaking button and alarm button for the actions. The safety of this inputs/outputs stage is enhanced, for example by means of connectors, more than for the other media which are not involved in the safety of the driver.

### Use of the Device 1

### Overtaking:

For an overtaking request, in a rally, the requestor activates the remote overtaking request button 15. The processor 33 collects, in real time, the GPS data which relate essentially to the position, the heading and the speed of the requestor vehicle. On a racetrack, there is no need to activate a button because the transmission of the signaling message is continual at the frequency of once per second.

Using his/her radiofrequency module 7, the requestor sends a message comprising the following information: the name of the competitor, the number of the equipment, the position, the heading, the speed, and an indication informing that he/she is making an overtaking request. This message is repeated three times, and between each repetition short random time delays are inserted in order to increase the robustness of the transmission. The message is sent in the form of a “broadcast” (from one to all). On a racetrack, the transmission of this message is automatic once per second, hence there is no need to make the overtaking request manually.

All the devices 1 within radio range receive the message via the radiofrequency module 7. The receiving vehicles engage an analysis of the message received by means of the processor 33:
a. If the GPS indications received are erroneous (such as a speed greater than 500 km/h, a position of more than 50 km (being out of radio range) for example, or missing information, etc.), then, for safety in a rally, the receivers activate the “overtaking request” signal (in the case of the use on a racetrack, the message is ignored and the system waits for the following one, sent one second later).
b. If the GPS data values are exact (those received and their own data values) but the speed of the requestor is below a low threshold (6 km/h, which can be varied), the request is ignored.

Depending on the difference in speed, on the distance between vehicles and on the angle of approach, after analysis of the vehicle profiles in the framework of the use on a racetrack and/or on the pre-programmed rules, the processor activates or does not activate the audible warning.

If the audible (or visual) warning has been activated, the receiver must inform the sender that it has indeed been informed of the overtaking request. This action may be manual (in particular for trucks, cars in a rally) by a short press on the remote acknowledgement button 15, which is done within the 6 seconds after reception of the request, or automatically. It is automatic in the case of the use on a racetrack, or for motorbikes in a rally, or for cars and trucks in a rally, if the manual acknowledgement has not been done.

An acknowledgement message is then sent from the device 1 of the receiver vehicle. The device 1 of the overtaking requestor, receiving the “manual” acknowledgement, indicates this acknowledgement by a brief activation of the buzzer 9 in a rally, or of the flash 12 on a racetrack. Advantageously, the sender will be informed by a message on the screen 27 if the vehicle to be overtaken is driven by an amateur driver with little experience. This information is obtained by virtue of the competitor number.

Otherwise, in the operation in a rally, if the receiver vehicle has not acknowledged the request within the 6 seconds, the processor 33 controls the sending of an automatic acknowledgement from the radiofrequency module 7 of the device 1 of the receiver vehicle. The requestor vehicle then receives an automatic acknowledgement indicated to it by an activation of the buzzer 9 with a specific sequence. It therefore knows that the request has actually technically been received, but that the receiver driver has not acknowledged it.

In each device 1, all the radio exchanges are logged and a trace is recorded. It is therefore possible to reproduce the overtaking sequences at a later time in the case of litigation.

### Alarm Activation:

Following an accident which is hidden from view, the competitor decides to activate his/her alarm by pushing the alarm trigger button 18. This operation is used in the case of rallies. On a racetrack, the alarm can advantageously be given by the race director equipped with a system and positioned on the side of the racetrack as close as possible to the accident.

All the competitors within radio range will receive this radio message qui notably comprises the number and the position of the competitor having sent it.

A first analysis consists in verifying the validity of the information received and in activating the alarm alert if the data are incorrect (this can happen if, for example, as a result of an accident, the GPS antenna has been damaged).

If the data are correct, an analysis of the position, of the speed and of the heading will decide the relevance of signaling the vehicle with the alarm. Once the signaling from the receiving driver has been activated, the latter can activate a silent mode by a short push on the overtaking button 15. This allows him/her to disable the buzzer 9 for 1 minute.

### Speed Alarm Mode:

In a Rally Raid, the competitors are obliged to pass through zones with speed limits (village). All these zones are stored in the memory 36 or of the device 1.

When a competitor enters into a zone with a speed limit, a routine for verification of the speed is activated. If the vehicle comes close to the speed limit, the buzzer 9 starts to “beep” until it emits a continuous whistle when the limit is reached. When exiting the zone, the routine is disabled.

### Management Mode:

The management mode uses three separate protocols:
broadcast: this mode is necessary for updating all the competitors within a limited time (before the start for example). These updates are carried out each time there is a modification of the route or of the parameters;
unload dialogue: this allows the trace and the events to be recovered from each device 1;
test dialogue: this allows the signaling of a device 1 to be activated using computer hardware (PC). This function allows the correct operation of the whole chain (radio and signaling media) to be verified.

1-8. (canceled)

9. A method for assistance in overtaking a vehicle in a framework of a vehicle race, comprising the steps of:
transmitting by radiofrequency, a global positioning data acquired by a satellite global positioning module coupled to a radiofrequency module from a requestor vehicle to a receiver vehicle;
analyzing the global positioning data received from the requestor vehicle by the receiver vehicle; and
warning a driver of the receiver vehicle of an imminence of an overtaking maneuver based on a relevance of the analyzed global positioning data by the receiver vehicle and transmitting a radiofrequency signal from the receiver vehicle to the requestor vehicle that the receiver vehicle has been made aware of an imminent overtaking maneuver.

10. The method as claimed in claim 9, further comprising the step of manually transmitting the radiofrequency signal to the requestor vehicle that the driver of the receiver vehicle has been made aware of an imminent overtaking maneuver by the receiver vehicle.

11. The method as claimed in claim 9, further comprising the step of automatically transmitting the radiofrequency signal to the requestor vehicle that the driver of the receiver vehicle has been made aware of an imminent overtaking maneuver by the receiver vehicle.

12. The method as claimed in claim 9, wherein a time delay between two radiofrequency transmissions, for same overtaking request by the requestor vehicle, is random and less than 250 ms.

13. The method as claimed in claim 9, wherein the radiofrequency transmissions are continuous every second, synchronized over time using a time reference supplied by the satellite global positioning module.

14. The method as claimed in claim 9, further comprising the step of waiting at least 6 seconds before renewing an overtaking request to same receiver vehicle by the requestor vehicle.

15. A device for managing the overtaking between various vehicles in a vehicule race, comprising:
a satellite global positioning module configured to acquire a global positioning data;
a radio frequency module configured to transmit and receive radiofrequencies, the radiofrequency module coupled to the satellite global positioning module by a data processing motherboard;
a processor equipped with a storage system to store acquired data and connected to the data processing motherboard, the processor configured to analyze the global positioning data received from a requestor vehicle;
at least one signaling device configured to warn a driver an imminence of an overtaking maneuver based on a relevance of the analyzed global positioning data by the processor;
at least one actuator;
a screen;
a keyboard;
a power supply; and
wherein the radiofrequency module is configured to transmit the global positioning data acquired by the satellite global positioning module to a receiver vehicle and to transmit a radiofrequency signal to the requestor vehicle that the receiver vehicle has been made aware of an imminent overtaking maneuver.

16. The device as claimed in claim 15, wherein said at least one actuator is a manual actuator.

17. The device as claimed in claim 15, wherein said at least one actuator is an automatic actuator.

18. The device as claimed in claim 15, wherein the signaling device is an audible or visual warning indicator.

19. The device as claimed in claim 15, further comprising two manual actuators: a main remote button to initiate overtaking requests and a secondary remote button to activate an alarm.

20. The device as claimed in claim 15, wherein the screen is a transflective color screen driven by the data processing motherboard and comprises a display mode for safety indications to be used as signaling media.

21. The device as claimed in claim 15, wherein the vehicles are cars, trucks, motorbikes and quad bikes.
